(19) United States
(12) Patent Application Publication
(10) Pub. No.: US 2007/0083553 A1
(43) Pub. Date: Apr. 12, 2007

(54) Apparatus and methods for handling multimedia content in an electronic device

(76) Inventor: Sten Minor, Lund (SE)

Correspondence Address: MYERS BIGEL SIBLEY & SAJOVEC, P.A., P.O. BOX 37428, RALEIGH, NC, 27627, US

(21) Appl. No.: 11/248,628

(22) Filed: Oct. 12, 2005

(51) Int. Cl. G06F 17/00

(52) U.S. Cl. 707/104.1

(57) ABSTRACT

A method of handling multimedia content related data at an electronic device configured to communicate with a multimedia content source providing downloadable multimedia content includes receiving multimedia content related data at the electronic device, the multimedia content related data including a list of one or more items of multimedia content related data provided as a coded list of items of multimedia content, in which list at least one item of multimedia content may be identified by a unique code, and processing the multimedia content related data to thereby locate a multimedia content source from which an item of multimedia content corresponding to the unique code may be obtained.

### FIELD OF THE INVENTION

The present invention relates to the handling of multimedia content by an electronic device, and more particularly to electronic devices and methods for locating a multimedia content source.

### BACKGROUND

It is known within the field of computers and wireless communication to transmit different types of multimedia content. The multimedia content can for example be video-files, pictures (still and moving pictures), as well as sound files or any combination thereof. Typically, such multimedia content can be downloaded, or streamed to electronic devices, for instance to communication devices such as mobile phones, or different types of stationary or portable computers.

Because of the ever increasing amount of such available multimedia content, and because user may be subject to more and more influences related to such multimedia content, for instance on music genres, tunes, artists etc., from an increasing amount of sources, such as friends, TV and radio broadcastings, or the web, some users may have problems with handling, and in particular locating, a suitable multimedia content source to get access to a desired content.,

For instance, once a user has been influenced to desire a particular recording by a source, such as a friend proposing a recording or music sample he should listen to, finding the original recording for purchasing or listen to a music sample, may typically require quite a lot of manual work. For example, a user may need to first locate the artist, the music album, the tune, and, finally, to locate a source for downloading or streaming the content to an electronic device to be able to listen to the recording or music sample.

Other problems may impede the process of finding and/or obtaining multimedia content. For example, it is sometimes difficult to compare offerings available from different sources, for instance as regards finding the best price before downloading and/or streaming a multimedia program or file.

Thus, there may be a number of problems related to locating a source for providing multimedia content.

### SUMMARY

According to some embodiments of the invention, a method of handling multimedia content related data at an electronic device configured to communicate with a multimedia content source providing downloadable multimedia content includes receiving multimedia content related data at the electronic device, the multimedia content related data including a list of one or more items of multimedia content related data provided as a coded list of items of multimedia content, in which list at least one item of multimedia content may be identified by a unique code, and processing the multimedia content related data to locate a multimedia content source from which an item of multimedia content corresponding to the unique code may be obtained.

Processing multimedia content related data may include downloading additional data automatically in response to receiving the multimedia content related data and/or in response to a user input.

The method may further include downloading or streaming an item of multimedia content identified in the list, the electronic device may include an application processing unit, and downloading or streaming an item of multimedia content may be initiated by a client application running in the application unit.

An item in the list may refer, for example, to an audio file.

The list may include at least a first item of multimedia content related data referring to a first item of multimedia content having a first content type and a second item of multimedia content related data referring to a second item of multimedia content having a second content type, different from the first content type. For example, the first content type may be audio and the second content type may be video.

The method may further include storing the multimedia content related data before processing thereof.

An electronic device according to some embodiments of the invention includes at least one transceiver unit configured to communicate with a multimedia content source providing downloadable multimedia content, and further configured to receive and/or send multimedia content related data including at least one list of one or more items of multimedia content related data provided as a coded list of items of multimedia content, in which list each item of multimedia content may be identified by a unique code by which a multimedia content source providing downloadable multimedia content may be located.

The electronic device may further include an application unit configured to process the list. The application unit may further be configured to connect to a multimedia content provider to download further data relating to an item of multimedia content referenced in the list and/or to download and/or stream a multimedia content sample relating to an item of multimedia content referenced in the list.

The application unit may be further configured to connect to a multimedia content provider in response to a user input to download further data relating to an item of multimedia content referenced in the list, and/or to download, or stream a multimedia content sample relating to an item of multimedia content referenced in the list. The application unit may include, for example, a music client.

An electronic device according to some embodiments of the invention may further include a data presentation unit configured to display at least a portion of the list.

The electronic device may include, for example, a computer and/or a portable communication device such as a cellular telephone.

A computer program product according to some embodiments of the invention includes a computer readable storage medium having computer readable program code embodied in the medium, the computer readable program code including computer readable program code configured to receive multimedia content related data at the electronic device, the multimedia content related data including a list of one or more items of multimedia content related data provided as a coded list of items of multimedia content, in which list at least one item of multimedia content may be identified by a unique code, and computer readable program code configured to process the multimedia content related data to thereby locate a multimedia content source from which an item of multimedia content corresponding to the unique code may be obtained.

The computer readable program code may further include computer readable program code configured to transmit the multimedia content related data from the electronic device.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 shows an electronic device in the form of a cellular phone according to some embodiments of the invention;

FIG. 2 shows the phone of FIG. 1 connected to a multimedia content provider in the form of a server via a cellular network;

FIG. 3 shows a block schematic of the some components of the phone of FIG. 1 according to some embodiments of the invention;

FIG. 4 shows a flow chart of operations according to some embodiments of the invention, which may be performed in the phone;

FIG. 5 shows a play list according to some embodiments of the invention;

FIG. 6 shows a flow chart of operations according to some embodiment of the invention; and

FIG. 7 shows a CD ROM on which program code for controlling operations according to the invention may be provided.

### DETAILED DESCRIPTION OF EMBODIMENTS OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

As will be appreciated by one of skill in the art, the present invention may be embodied as a method, data processing system, and/or computer program product. Accordingly, the present invention may take the form of an entirely hardware embodiment, an entirely software embodiment or an embodiment combining software and hardware aspects all generally referred to herein as a “circuit” or “module.”Furthermore, the present invention may take the form of a computer program product on a computer usable storage medium having computer usable program code embodied in the medium. Any suitable computer readable medium may be utilized including hard disks, CD ROMs, optical storage devices, a transmission media such as those supporting the Internet or an intranet, or magnetic storage devices.

The present invention is described below with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

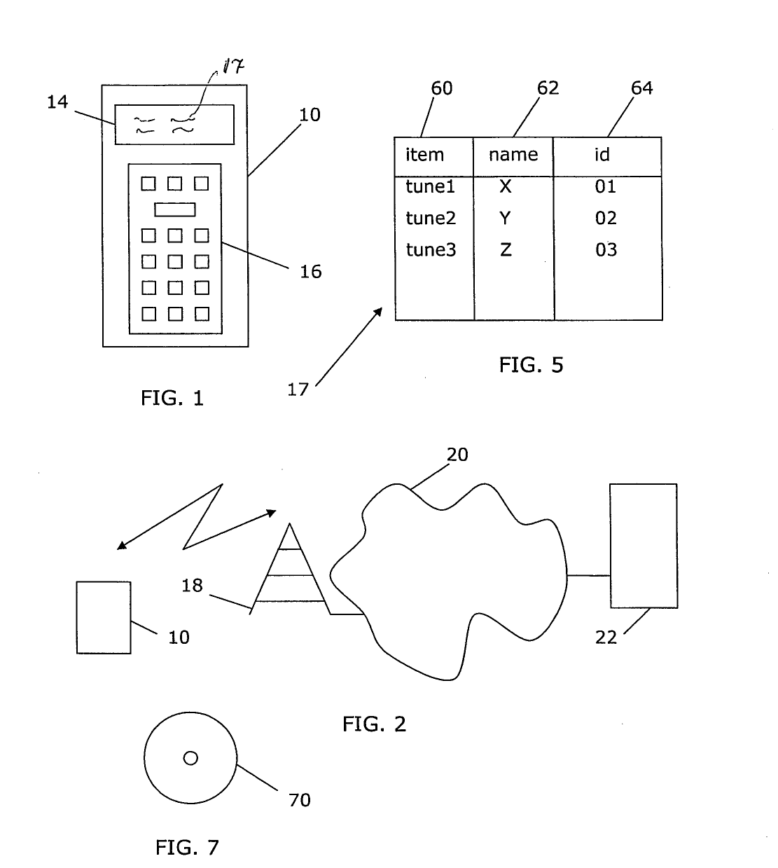

An electronic device 10 according to some embodiments of the invention is shown in FIG. 1. In some embodiments, the electronic device is 10 may be and/or include a cellular telephone. The device 10 may have a user interface that may include, for example, a display 14 and a keypad 16 including a number of keys. In addition to making and receiving telephone calls, the keypad 16 may be used for selecting applications and/or entering information related thereto, for instance to order downloading of multimedia content and responding to prompts. The display 14 may be used for displaying information related to applications, and may be used to provide notifications and/or prompts to a user of the device 10. The device 10 is configured to communicate with other electronic devices such as, for example, other cellular telephones belonging to other users via a network, or via an alternative communication route, such as infrared (IR) and/or Bluetooth communication typically provided for shorter communication routes, e.g., within a few meters of distance. The device 10 is configured to manipulate a list 17 of multimedia content related data (shown schematically in FIG. 1), in which data related to multimedia content can be associated with specific multimedia content.

The list 17 may itself not contain any multimedia content, but may just include a list of references to multimedia content such as, for example, songs. In some embodiments, the list 17 of data may include one or more items related to multimedia content. In some embodiments, the list 17 may include a coded list of items, hereinafter referred to as a “play list”, that are identified by a unique code or identification (identification may be referred to herein as “id”). By means of the unique code or id, it may be possible to subsequently locate a multimedia content source for obtaining a desired multimedia content according to the play list. A play list as described above may be easily communicated to another user. Thus, multimedia content, for instance songs, can be streamed or downloaded to a device from any available music store, or streaming server. The list 10 may also include data identifying a format of the content, such that the device 10 may easily determine if the device 10 is configured to play/display the content. If not, the device 10 may be configured to automatically download a driver, a CODEC or other software or code that may enable the device 10 to play/display the content. It is also possible to transmit the play list 17 to another phone, possibly supporting another music format. In this way, multimedia content, such as tunes can be shared between phones with support for different music formats and (Digital Rights Management) DRM schemes. The appearance of the play list 17 and the features thereof will be described in more detail below with reference to FIG. 5.

A cellular phone is just one example of an electronic device in which the invention can be implemented. Some embodiments of the invention may also be used, for example, in a PDA (personal digital assistant), a palm top computer, a lap top computer and even on a regular stationary computer such as a PC (Personal Computer), including all types of network-enabled media players, such as a wireless or W-LAN enabled media player.

FIG. 2 shows a device 10 connected to a cellular network 20 via a base station 18 for communication with a multimedia content provider 22, for instance in the form of a server, also connected to the network 20. The network 20 may, for example, include a GSM-type of network and/or a GPRS network. It is of course also possible that the network 20 is a WCDMA network. In the illustrated embodiments, the multimedia content provider 22 is a server configured to transmit multimedia content as well as data related to the multimedia content. Any other suitable source configured to provide multimedia content could be utilized. Thus, the invention is by no means limited to a server operating as a multimedia content provider. Typically, the multimedia content provider 22 is provided to transmit multimedia content (typically stored in the server or accessible from yet another source (not shown)) such as digital multimedia content in the form of music, video clips, images, books, audio books etc to an electronic device, as well as data related thereto, on demand, to the device 10.

The number of electronic devices (for instance cellular phones) 10 that may communicate with the multimedia content provider 22 can be far more than the single one as shown in FIG. 2. The device 10 could just as well communicate with another phone, a PDA or a computer via the network 20 (or by means of using IR or the like for shorter distances). The multimedia content provider 22 can be directly connected to the cellular network 20 as shown, or be connected to the same via some other intermediate network (not shown). The network 20, or any further network need not include a cellular network, but can be some other type of network, such as the Internet, a corporate intranet, a LAN or a wireless LAN. It can also be a so-called PSTN (Public Switched Telephone Network). This figure has been enclosed for showing an environment in which the invention can be provided, but is by no means intended to limit the invention to this configuration only. Moreover, it should be realised that the application need not require any cordless communication with other devices, in which case the connection via a network 20 might not be necessary. Thus, alternatively, it might in some applications, be suitable to provide a physical connection such as a cord between two electronic devices 10 instead, to be able to perform the invention.

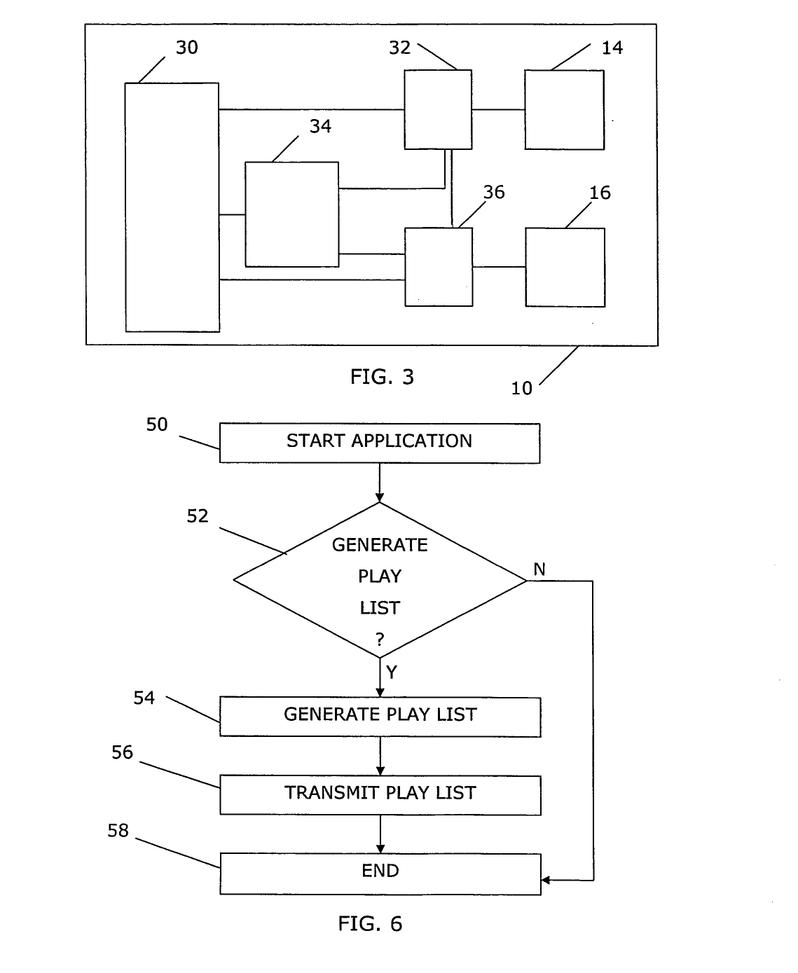

FIG. 3 shows some components of the device 10 that may be operated in association with some embodiments of the present invention. The device 10 includes a transceiver unit 30 associated with an application for handling multimedia content. The transceiver unit 30 is arranged to receive and/or transmit (send) multimedia content and/or data related thereto, in particular in the form of a list of data.

The transceiver unit 30 is connected to an application unit 32 configured to handle multimedia content and data related thereto. A storage 34 in which data may be stored before being handled by or after being handled by the application unit 32 is also connected to the transceiver unit 30. The storage 34 is optional. A presentation unit 14 (e.g. the display 14 shown in FIG. 1) is typically connected to the application unit 32. The presentation unit 14 may be optional, however. The transceiver unit 30, the application unit 32 and the storage 34 are typically all controlled by a control unit 36, typically also implemented for controlling other parts of the device 10, which control unit 36 in turn may also be connected to the keyboard 16 or some other suitable user input device for controlling the electronic device 10 and applications. Of course also some other type and/or number of user input device and/or presentation unit(s) may be provided instead than shown in relation to this embodiment of the invention.

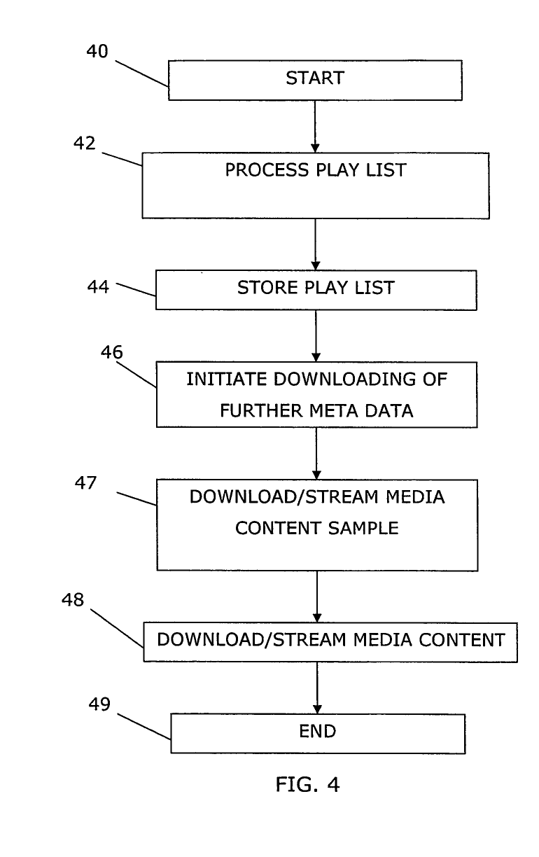

FIG. 4 shows a flow chart of operations according to an embodiment of the invention.

FIG. 5 shows how a play list 17 may be arranged in the form of items 60, each having thereto corresponding data 62 and id 64. In FIG. 5 there is shown three such items 60, where a first item, a sound-file, tunel is represented by unique id data 01 and a name X, a second item, tune2 corresponds to a second sound-file, and a third item, tune3 corresponds to a third sound-file, all together making up the play list 17. The data in the list may include meta data (i.e., data about data), which may provide additional information about the item of multimedia content referenced by the list item. As used herein, the term “data” includes meta data. It will be appreciated that a single “play list” may include references to various types of multimedia content. Thus, for example, a play list may include references to audio content, video content, podcasts, ring tones, etc. The data related to the play list could have been placed in the list in several different ways. It could have been received via a WAP or Internet browser, received via e-mail, a multimedia message service (MMS) and/or an enhanced message service (EMS), or downloaded or received in some other way. The data may be generated locally in the device 10 and/or or provided in the device beforehand, or even purchased for instance from a music store. In this figure, data such as names 62 have been included, only to give an example of an application, but is optional. Other data, music samples etc or no such data at all could have been provided instead. A multimedia file referenced in a play list 17 may be downloaded to the device 10 and/or may be generated at the device 10, for example, using a microphone and/or camera built into the device 10. In order to ensure that a unique id is used for a multimedia file generated at the device 10, the id may include, for example, an electronic serial number, MAC address, or other identifier unique to the device 10 as part of the id for the multimedia file.

Some embodiments of the present invention will now be explained with reference to FIGS. 3, 4 and 5. Referring to FIG. 4, transceiver unit 30 receives, or has received, multimedia content related data in the form of a play list, for instance a play list as shown in FIG. 5 (block 40). For example, a play list 17 may have been created by another person (a friend for instance) and transmitted via the network 20 by means of EMS, e-mail, MMS or alternatively by means of an IR, Bluetooth, W-LAN or other connection. The multimedia content related data is then processed in the application unit 32 (block 42). For example, a play list 17 including references to different items, for instance songs, and their unique ids is processed. The play list 17 may have been previously created in another cellular phone or other electronic device. In such case, the play list 17 may optionally be stored in the store 34 (block 44). The play list 17 may then be (or may later be) optionally used for locating a source for downloading further data relating to an item of multimedia content, such as, for example, meta data providing additional categorized or uncategorized information about the multimedia content (block 46). For example, where the multimedia content includes a song, the additional data could include data such as title, artist, genre composer of the song. Likewise, the play list 17 may optionally be used to locate a source for downloading a multimedia content sample (block 47). Finally, the multimedia content related to the play list 16 may be located and/or downloaded using the play list 17 (block 48). The foregoing operations may be performed by means of the application unit 32 (operating as a client, for instance a music client) ordering the content provider 22 (the source in this embodiment) to download or stream multimedia content (automatically or depending on user manipulation) according to the play list 17. It may not be necessary for a user to choose to download all items present in the play list 17, but any number of items desired could easily be selected by means of user input from a user input unit 16 such as the user interface.

Accordingly, a user may obtain access to streamed and/or downloaded music or other types of multimedia content. A user could listen to samples from a music store or streaming server by means of processing the play list, or files selected therefrom without having to manually locate each desired item.

As an alternative to a user providing another user with the play list 17, a content provider 22 such as a broadcasting server may publish, for example, on a web page on the internet, downloadable play lists (which may have to be purchased, but could also be available for free) containing, for example, what is broadcasted and what has been broadcasted during a particular period of time, for instance a particular day, week or month. In this case, the play list 17 could also be provided by the user.

Herein, the term “content provider” is intended to include, but is not limited to, broadcasting channels, but also individuals, magazines, companies, etc. In such cases, the content provider could for instance decide to publish a play list according to almost any preference, for instance related to favorite music of celebrities, recommended listening, examples of different genres etc, that can be downloaded for a user to get access to the multimedia content. Links, or other references may also be provided to other sources for downloading/streaming in case the service provider itself does not provide such a service.

When several sources are available, it may also be possible for a user to choose between different alternatives, for instance to be able to select one for downloading based on a preference or set of preferences including, for example, cost, reliability and/or connection speed.

Further operations according to embodiments of the invention, in which a user of an electronic device may create a personal play list for transmission to another user are shown in FIG. 6.

Referring to the embodiments of FIG. 6, the application is started (block 50). The user may be prompted with a question “Generate play list?”, for instance displayed on the presentation unit 14 (block 52). If the user then chooses to generate a play list, the application is run to generate a playlist for example by identifying a list of items to be included on the playlist and obtaining/assigning a unique id to each item on the playlist (block 54). After the playlist has been generated, it may be transmitted to another user (block 56).

Some embodiments of the present invention have been described in relation to an electronic device provided for cordless communication in the form of a cellular phone, in which the parts relevant for the invention has been schematically shown and illustrated only (FIG. 3). These and other parts of the invention, like at least part of the application unit, can also be provided in the form of one or more processors with corresponding program memories containing suitable software code. The software for performing the method can also be provided on a computer readable medium like a disc 70 of the CD ROM type as depicted in FIG. 7 or on some other type. In this case the software for performing the method when loaded into the phone or a computer will be provided on this disc. The program code can also be downloaded remotely from a server either outside or inside the cellular network or be downloaded via a computer like a PC to which the phone is temporarily connected.

Because according to some embodiments of the invention, data, for instance in the form of a play list, is checked instead of performing a complete download of multimedia content, less system resources may be used than when downloading multimedia content, which typically requires decoding and/or streaming. Also, the time required for finding a suitable source for downloading multimedia content may be reduced, and multiple sources of a media program, such as a song recording, may be compared before downloading the program on the basis of one or more criteria, such as price, reliability, download speed, etc.

While embodiments of the invention have been described in connection with the location and downloading of audio programs such as songs and audio samples, embodiments of the invention may be advantageously employed in the process of finding and/or obtaining other types of multimedia content, such as, for example, video clips, pictures, television shows, podcasts, mobile telephone ring tones, skins, visualizations, themes, screensavers, and the like. Thus, the present invention is be no means limited to locating recordings or music samples, but may be advantageously employed for locating and/or obtaining all types of multimedia content.

The phone in this description uses radio circuits in order to communicate with other devices. These radio circuits have however not been described here since they are not really part of the invention and since this communication is performed in a way already known within the art.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A method of handling multimedia content related data at an electronic device that is configured to communicate with a multimedia content source providing downloadable multimedia content, the method comprising:
receiving multimedia content related data at the electronic device, the multimedia content related data comprising a list of one or more items of multimedia content related data provided as a coded list of items of multimedia content, in which list at least one item of multimedia content is identified by a unique code; and
processing the multimedia content related data to locate a multimedia content source from which an item of multimedia content corresponding to the unique code may be obtained.

2. The method of claim 1, wherein processing multimedia content related data comprises downloading additional data automatically in response to receiving the multimedia content related data and/or in response to a user input.

3. The method of claim 1, further comprising downloading or streaming an item of multimedia content identified in the list, wherein the electronic device includes an application processing unit, and downloading or streaming an item of multimedia content is initiated by a client application running in the application unit.

4. The method of claim 1, wherein an item in the list refers to an audio file.

5. The method of claim 1, wherein the list includes at least a first item of multimedia content related data referring to a first item of multimedia content having a first content type and a second item of multimedia content related data referring to a second item of multimedia content having a second content type, different from the first content type.

6. The method of claim 5, wherein the first content type is audio and the second content type is video.

7. The method of claim 1, further comprising storing the multimedia content related data before processing thereof.

8. An electronic device, comprising:
at least one transceiver unit configured to communicate with a multimedia content source providing downloadable multimedia content, and further configured to receive and/or send multimedia content related data comprising at least one list of one or more items of multimedia content related data provided as a coded list of items of multimedia content, in which list each item of multimedia content is identified by a unique code by which a multimedia content source providing downloadable multimedia content may be located.

9. An electronic device according to claim 8, further comprising an application unit configured to process the list.

10. An electronic device according to claim 9 wherein the application unit is further configured to connect to a multimedia content provider to download further data relating to an item of multimedia content referenced in the list and/or to download and/or stream a multimedia content sample relating to an item of multimedia content referenced in the list.

11. An electronic device according to claim 9, wherein the application unit is further configured to connect to a multimedia content provider in response to a user input to download further data relating to an item of multimedia content referenced in the list, and/or to download, or stream a multimedia content sample relating to an item of multimedia content referenced in the list.

12. An electronic device according to claim 9, wherein the application unit comprises a music client.

13. An electronic device according to claim 8, further comprising a data presentation unit configured to display at least a portion of the list.

14. An electronic device according to claim 8, wherein the electronic device comprises a computer.

15. An electronic device according to claim 8, wherein the electronic device comprises a portable communication device.

16. An electronic device according to claim 15, wherein the electronic device comprises a cellular telephone.

17. A computer program product for handling multimedia content, the computer program product comprising:
a computer readable storage medium having computer readable program code embodied in said medium, said computer readable program code comprising:
computer readable program code configured to receive multimedia content related data at the electronic device, the multimedia content related data comprising a list of one or more items of multimedia content related data provided as a coded list of items of multimedia content, in which list at least one item of multimedia content is identified by a unique code; and
computer readable program code configured to process the multimedia content related data to thereby locate a multimedia content source from which an item of multimedia content corresponding to the unique code may be obtained.

18. The computer program product of claim 17, wherein the computer readable program code further comprises:
computer readable program code configured to transmit the multimedia content related data from the electronic device.
